(19) United States
(12) Patent Application Publication
(10) Pub. No.: US 2017/0328451 A1
(43) Pub. Date: Nov. 16, 2017

(54) Down-Hole Roto-Linear Actuator

(71) Applicant: Kress Technology, LLC, f/k/a Kress Motors LLC, Ligonier, PA (US)

(72) Inventor: Brian K. Ott, Windber, PA (US)

(73) Assignee: Kress Technology, LLC, f/k/a Kress Motors LLC, Ligonier, PA (US)

(21) Appl. No.: 15/525,598

(22) PCT Filed: Nov. 12, 2014
(86) PCT No.: PCT/US14/65191

§ 371 Date: May 10, 2017

(51) Int. Cl. F16H 25/22; E21B 7/06; E21B 21/08; E21B 21/10; E21B 4/00; F16H 25/20; E21B 21/00; E21B 34/00; F16H 25/00

(52) U.S. Cl. CPC F16H 25/2204; E21B 21/103; E21B 7/067; E21B 21/08; E21B 4/00; E21B 21/00; E21B 34/00; F16H 25/00; F16H 2025/2078

(57) ABSTRACT

Disclosed is an actuator capable of imparting a linear, rotary, or combined roto-linear force. In one embodiment, the actuator has a rotor and a stator, each having helical grooves with a thrust ball occupying the grooves. A nose piece is situated at the end of the actuator and can be attached to other equipment. The actuator is electrically controlled and can be used in applications requiring high forces or other specialized environments.

### CROSS-REFERENCE TO RELATED APPLICATIONS

The present application is a 35 U.S.C. 371 US national phase application of PCT international application serial number PCT/US2014/065191, entitled “DOWN-HOLE ROTO-LINEAR ACTUATOR” filed on Nov. 12, 2014, incorporated by reference herein in its entirety.

### FIELD OF THE INVENTION

The present invention relates generally to actuators. More specifically, the invention relates to electrically-controlled actuators that can impart a linear or a rotary force through an angular displacement.

### BACKGROUND OF THE INVENTION

There is a need for an actuator in down hole drilling to control mud flow to a drill head which is down hole 8,000 to 15,000 feet. However, it is generally very difficult to control such devices from the surface so as to accurately control the drill bit mud valve. The reason for that is that the pressure at such depths is about 30,000 PSI. In addition to the pressure, the temperature is generally quite extreme (about 280° F.) and silicon based electronic control devices generally do not operate at such temperatures. While some silicon carbide devices are available, they are highly specialized and extremely expensive, and must be used judiciously. In addition to the high pressure, high temperatures become an increasingly greater issue. The operating temperatures are about 320° F. in the bore hole. Finally, at those distances, it becomes very difficult to send high-power electrical signals down the wire and accurately control from 8,000 to 15,000 feet below the controller. The control signals tend to change from where they originate to the location where they are needed and the final wave shape becomes unacceptable. Accordingly, it is preferable to have the power-electronics portion of the control means located directly behind the drill head with the control means being able to accept low-power control signals from the top-side surface.

### BRIEF SUMMARY OF THE INVENTION

The present invention relates to the use of actuators to provide force through an angular displacement which is less than a complete revolution of a rotor turning around a stator. This force can be either an angular-linear (roto-linear) displacement or, when combined with a ball screw assembly and a force-transfer element, becomes a linear force displacement or an angular force displacement. The present invention can provide a short stroke and high force roto-linear phase-modulated actuation for use in down-hole drilling-mud valves and the like. Alternatively, the actuator of the present invention can provide only angular displacement

### BRIEF DESCRIPTION OF THE DRAWINGS

FIG. 1A is an elevation of the stator subassembly of an actuator according to one embodiment of the present invention showing the integrated-threaded mounting tube, stator frame body, internally embedded stator magnetic elements, external helical ball grooves, and lead wires.

FIG. 1B is an end-view of the actuator stator subassembly showing the radial location of the stator core embedded in the stator frame.

FIG. 1C is a side elevation of the actuator external rotor subassembly showing the internal helical ball grooves, the internal magnetic rotor elements (or permanent magnets), the linear/torsional transfer element, and the output shaft.

FIG. 1D is a side elevation of the structures depicted in FIGS. 1A, and 1C assembled into a single unit representing the actuator.

FIG. 1E is an isometric exploded view the actuator shown in FIG. 1D.

FIG. 1F is a side elevation of the actuator in partial section showing electrical control means connected to a topside control means.

FIG. 2A is an elevational side view of a preferred rigid configuration of a force-transfer element which is used in a roto-linear actuator.

FIG. 2B is an elevation view with a cut away side view of the linearly-rigid configuration of the force transfer element of the actuator.

FIG. 2C is an elevational side view detail with a cut-away showing a torsionally-rigid configuration of the force transfer element.

FIG. 3A is a side-view of an angular displacement actuator stator subassembly, according to one embodiment of the present invention, showing the integrated-threaded mounting tube, stator frame body, internal-embedded asymmetric stator element(s), rotation stop and return-spring tang, and lead wires.

FIG. 3B is an end-view of the angular displacement actuator stator subassembly showing the radial location of the asymmetric stator core embedded in the stator frame, the return spring, and the rotation stop and spring tang.

FIG. 3C is a perspective side-view of the angular displacement actuator external rotor subassembly showing the internal magnetic rotor elements (or permanent magnets), the return spring and the rotation stop.

FIG. 3D is an end-view of the angular displacement actuator rotor subassembly showing the outer cylindrical housing, and depicts the radial location of the return spring and the rotation stop.

FIG. 3E is a perspective side-view the items depicted in FIGS. 3A, and 3C assembled into a single unit representing the angular displacement actuator.

FIG. 3F is a side elevation of the angular displacement actuator in partial section showing electrical control means connected to a topside control means.

### DESCRIPTION OF PREFERRED EMBODIMENTS

The present invention provides means for more accurate control of mud flow to the drill head at even greater depths. Generally the present invention provides an actuator 164 which includes a cylindrical stator assembly 100 which comprises a spaced apart semi annularly spaced thrust groove 116. In the preferred embodiment, a pair of thrust grooves is provided and each groove is separated by a distance along the length of the stator body. Each of these thrust grooves 116 angularly extends up to about 540 degrees around the exterior of the stator assembly 100. The stator houses an array of electrically-magnetizeable stator elements 124 positioned around the stator 100, positioned between the thrust grooves 116, and serve to interact with the magnetic elements 148 of the rotor assembly 140. The external helical grooves 116 on the stator assembly 100 provide a channel which partially contains a set of thrust balls 160 that mesh with coextensive matching thrust grooves 144 in the rotor assembly 140. The stator grooves 116 may be created in the manufacturing process by molding, or machining, or other methods known to a person having ordinary skill in the art.

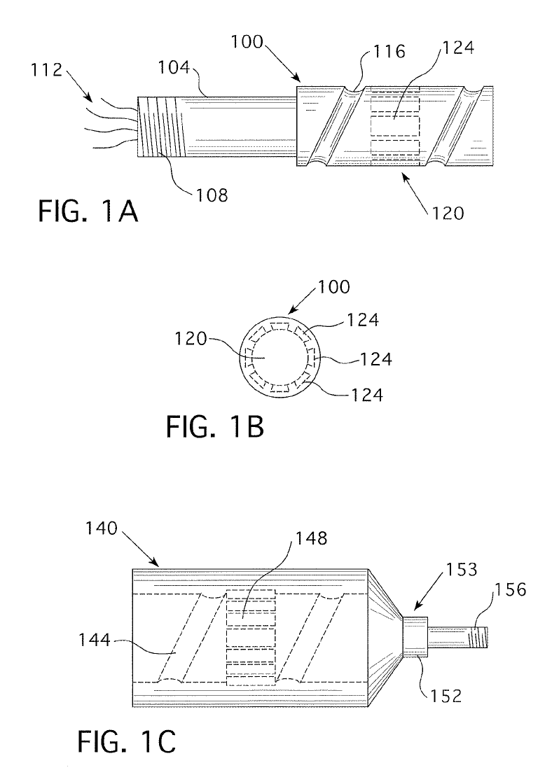

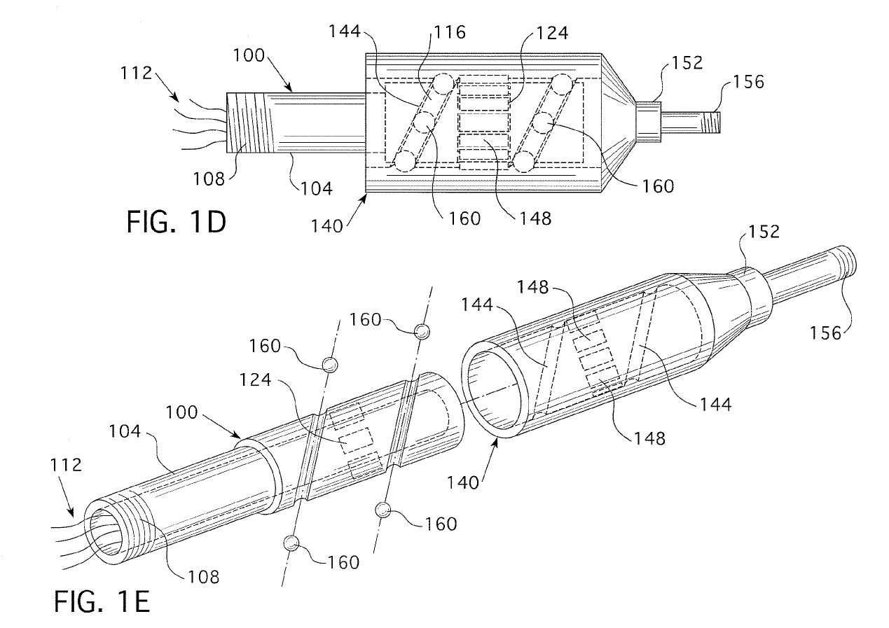

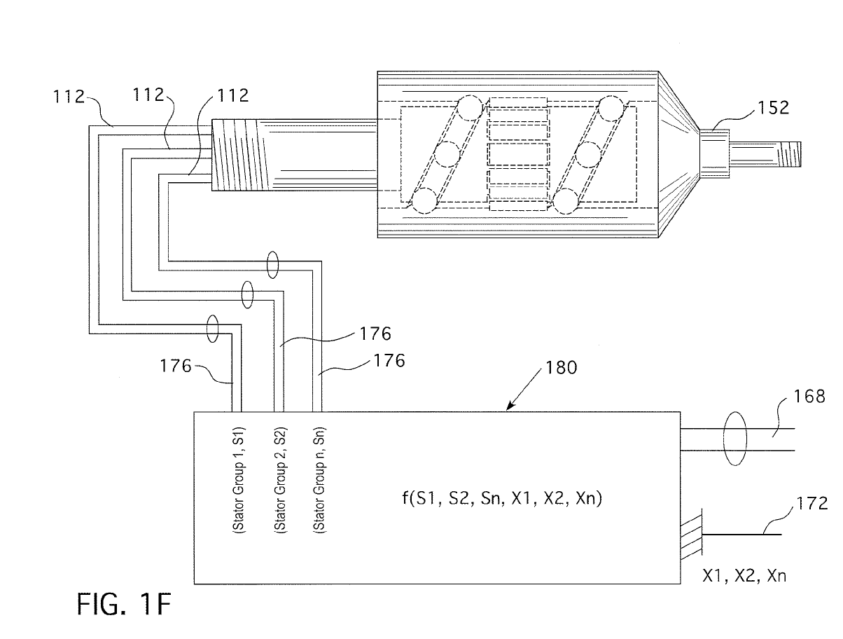

The actuator also includes a cylindrical rotor assembly 140 having an inner diameter adapted to rotatably accept the stator 100. That is, the rotor 140 has an interior space in which the stator 100 resides, as can be seen in FIGS. 1D and 1E. The rotor 140 has an array of magnetic rotor elements 148 positioned within and adjacent to the stator elements 124 at an application specific spacing, as will be described below. The rotor elements 148 are comprised of either permanent magnet material, or ferrous magnetically-permeable material. The rotor 140 includes a groove 144 that is co-exstensive with the groove 116 of stator 100. In the preferred embodiment, the rotor 140 has a pair of grooves 144 that align with the grooves 116 of the stator 100, forming a space that retains thrust balls 160. When assembled, the thrust balls 160 are placed within the channel of the rotor 140, and mesh with the co-extensive grooves 116 in the stator 100, to permit the angular movement of the rotor 140 upon the stator 100 to also impart a linear movement of the rotor 140 upon the stator 100. In other words, the thrust balls 160 and grooves allow a screw-like motion between the rotor 140 and stator 100. The internal grooves 144 on the rotor assembly 140 may be created in the manufacturing process by molding, or machining, or any other forming process. The rotor assembly 140 also includes conical nose piece 152 projecting from one end which interfaces with one or more tools used for working at depth. The other end of said rotor 140 provides access for the stator 100 there within. In one preferred embodiment, threads 108 on an end of the stator 100 provides for mounting the actuator 164 to another piece of equipment or a suitable carrier.

The helical pitch of the external grooves 116 on the stator, and the internal grooves 144 of the rotor 140, is governed by the linear force that is required from the actuator based upon the application that the actuator is designed for. If a short-stroke high linear-force displacement is required, the helical groove pitch will be shallower than if a high-stroke low linear-force displacement is required. That is, an actuator 164 with a shallow pitch will have a shorter linear displacement for one revolution of the rotor 140 when compared to the linear displacement of an actuator 164 with a steeper pitch over the same revolution.

As an example of one application-specific variation of the actuator, the linear stroke length is 0.18 inches and the force required is 125 pound-force. In this example, the required helical groove spacing is 3 inches, when the achievable angular displacement is 20 degrees. The achievable angular displacement is a function of the ratio of the number of salient electromagnetic stator elements 124 (12 in this example) to the number of salient magnetic rotor elements 148 (8 in this example). In this case a stroke frequency of 10 Hz leads to a supplied power of 0.032 hp and a device power consumption on the order of 50-150 W. Other variations of the present invention can be specified depending on the application for which it is being used.

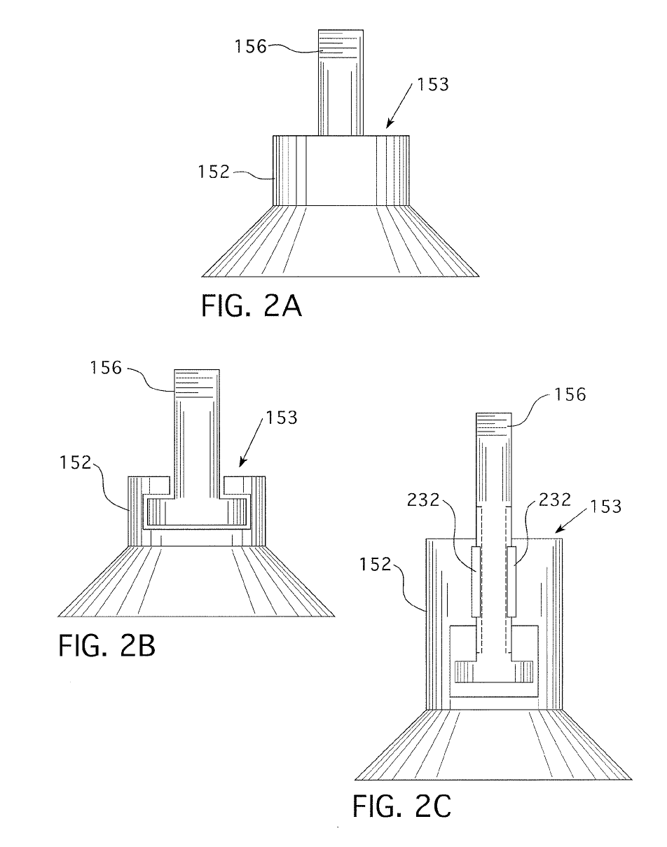

FIGS. 1A-1F show a presently preferred embodiment of a roto-linear embodiment of the present invention that provides either an angular force displacement, a linear force displacement, or both an angular and linear force displacement to a mechanical load. The type of force applied, linear, angular, or both, will depend on the configuration of the force transfer element 153, which is shown in FIGS. 2A-2C.

Referring to FIG. 1A, stator subassembly 100 includes an integrated mounting tube 104 having mounting threads 108. Stator subassembly 100 is preferably made from a nonmagnetic material, such as a high temperature resin. Mounting tube 104 is preferably a hollow cylindrical member that provides access for stator drive wires 112. Helical grooves 116 are provided on the outside surface of the stator subassembly 100 to convert an angular motion to a linear motion as more completely depicted by the roto-linear actuator 164 in FIG. 1D. The stator subassembly 100 is a pressure vessel that is molded around stator winding assembly 120. In the present embodiment, the stators poles 124 of stator winding assembly 120 are shown as separate stator cores. However, in alternative embodiments a one piece stator core with multiple salient poles 124 can be used.

As show in FIG. 1B the stator winding subassembly 120 is concentrically located within the body of stator subassembly 100. Stator poles 124 of the stator winding subassembly 120 are preferably encapsulated within a nonmagnetic body of the stator subassembly 100.

In FIG. 1C, a perspective view of the external rotor subassembly 140 of the roto-linear embodiment of the invention is shown. In rotor 140, the helical grooves 144 are provided on an inside surface of the rotor 140 and are congruent with helical grooves 116 in stator subassembly 100. When the helical stator grooves 116 and the helical rotor grooves 144 are aligned, with thrust balls 160 disposed in the space created by the overlapping grooves, angular motion is converted to linear motion as more completely depicted by the actuator 164 in FIG. 1D. The magnetic rotor elements 148 are preferably internal to the rotor, and are made of a magnetically permeable, or permanent magnet, material to produce torque when interacting with the magnetic flux produced by stator poles 124. The force transfer element 153 transfers only linear motion to output shaft 156 if transfer element 153 is linearly rigid and torsionally free, such as the transfer element shown in FIG. 2B. However, it can transfer only angular motion to output shaft 156 if transfer element 153 is torsionally rigid and linearly free, as shown in FIG. 2C. The transfer element 153 can transfer linear and angular motion to output shaft 156 if the transfer element 153 is both torsionally and linearly rigid.

Referring to FIG. 1D, a perspective view of an assembled roto-linear actuator 164 is shown. External helical grooves 116 on stator subassembly 100 align with the internal helical grooves 144 on rotor subassembly 140 and include within the formed grooves force transferring thrust balls 160. The entire assembly 164 is mounted for use via mounting tube 104 and mounting threads 108. Output linear and/or rotational force, or both, is transferred to the load by threaded output shaft 156. Output shaft 156 is threaded to allow the actuator to be attached to an additional tool or object. Alternatively, output shaft 156 is provided without threads.

An isometric exploded view of the major subassemblies—stator subassembly 100 and rotor subassembly 140—that make up the overall mechanical portion of the actuator 164 (FIG. 1D) is shown in FIG. 1E. External helical grooves 116 of stator subassembly 100 align with the internal helical grooves 144 on rotor subassembly 140 by means of force transferring balls 160. The entire assembly 164 is mounted for use by means of mounting tube 104 and mounting threads 108. Output linear and/or rotational force, or both, is transferred to the load by threaded output shaft 156.

FIG. 1F depicts a logical-electronic control means 180 of the roto-linear actuator 164. Interconnect wiring 112 from actuator 164 electrically connects to connection points 176 of the logical-electronic control means 180. Electrical power is supplied to the logical-electronic control means 180 via connection point 168, and logical control signals are passed to the logical-electronic control means via connection point 172. The control means 180 functions by providing power in the form of electronic drive signals to the stator coils in the actuator to affect the movement of rotor 140 about stator assembly 100. The instantaneous dynamic current of the stator coils in the stator is monitored by control means 180 in order to ascertain the position of the rotor, and/or the instantaneous-angular-torque/linear-force provided by the actuator to the load. The control means 180 is programmed with appropriated mathematical relations to affect the delivery of the required linear and/or angular force displacement to the load, and to dynamically adjust the drive parameters utilizing feedback resulting from monitoring the dynamic current values of the coils in the stator assembly 120. The control means 180 can be programmed, and actuated via the logical control port 172.

FIGS. 2A through 2C show different configurations of force-transfer-element 153. Force-transfer-element 153 may be configured to transfer both linear and angular motion displacement, transfer only linear displacement, or transfer only angular displacement. The selection of which element 153 to use is done in the initial configuration before being placed into service.

FIG. 2A shows a rigid configuration for force-transfer-element 153. In this embodiment of the element, collar 152 is rigidly connected, or is a monolithic structure with shaft 156. In this embodiment, the rotational and/or linear displacement that collar 152 is subjected to is transferred directly to shaft 156.

FIG. 2B shows the linearly rigid configuration for force transfer element 153. In this embodiment of the element, collar 152 is shaped in a manner that allows shaft 156 to rotate within collar 152, but permits any linear displacement imparted on collar 152 to be transferred to shaft 156.

FIG. 2C shows the torsionally-rigid configuration for force-transfer-element 153. In this embodiment of the element, collar 152 is shaped in such a fashion which allows shaft 156 to stroke within collar 152, but allows any angular displacement imparted on collar 152 to be transferred to shaft 156 via keyways and keys 232.

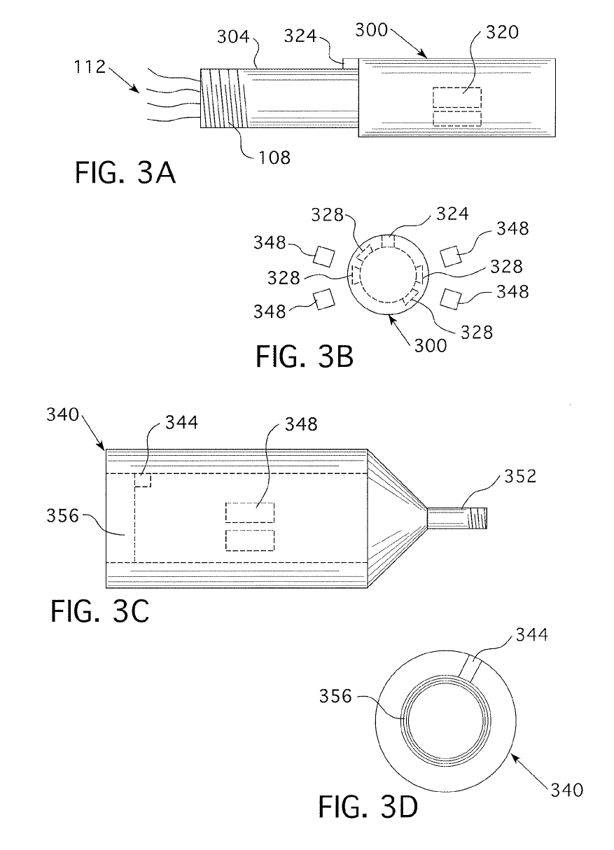

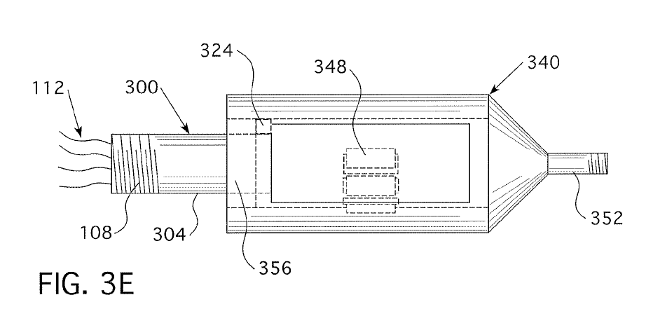

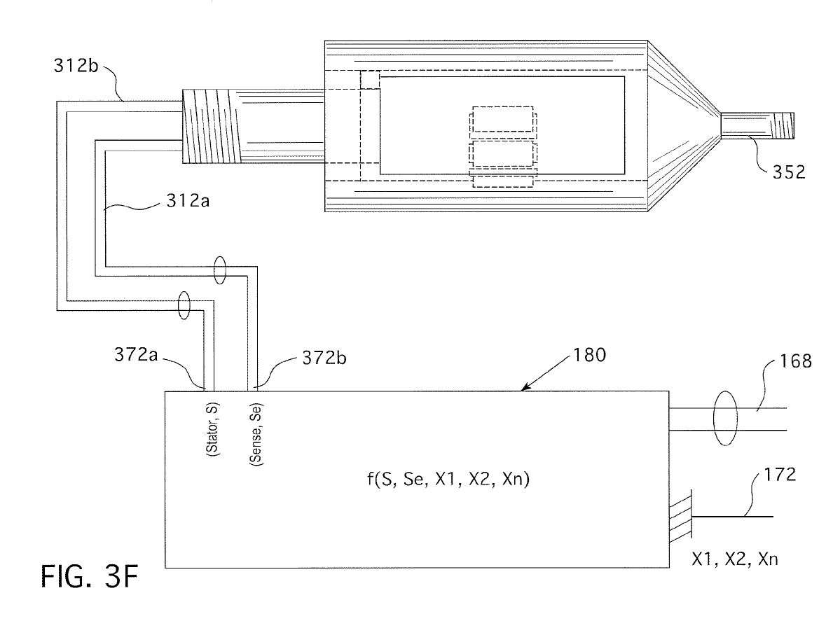

FIGS. 3A through 3F show an alternative embodiment of the present invention that provides angular force displacement to a mechanical load. The actuator in this embodiment provides powered angular displacement in one angular sense and utilizes a spring to return the angular displacement to the rest position and utilizes a multi-salient stator with a single winding. As shown in FIGS. 3A-3F, thrust grooves 116 and 144 are not present. Consequently, rotation of the rotor assembly 340 does not result in linear motion in this particular embodiment.

Referring to FIG. 3A, a perspective view of the stator subassembly 300, integrated mounting tube 304, and mounting threads 108. Mounting tube 304 is a hollow member and provides access to stator drive wires 112. The multi-salient single winding stator 320 is shown and spring return stop tab 324 is also displayed.

As show in FIG. 3B the stator winding subassembly 320 is concentrically located within the body of the device 300, and the salient poles 328 of the stator winding subassembly 320 are totally encapsulated within the non-magnetic body of the stator subassembly 300.

FIG. 3C is a perspective view of the external rotor subassembly 340 of the device. The salient magnetic rotor elements 348 are internal to the rotor, and are made of a magnetically permeable material in order to produce torque when interacting with the magnetic flux produced by the stator poles 328. The ridged-threaded output shaft 352 is shown at the drive end of the external rotor subassembly 340. The return spring 356 is shown as well as the return spring retaining tang and stop tab 344.

As shown in the end view of rotor subassembly 340 in FIG. 3D, the housing is visible and the return spring 356, the return spring retaining and stop tab 344 are shown.

FIG. 3E is an elevation of the angular displacement actuator according to the alternative embodiment of the present invention. The multi-salient stator poles 320 and magnetic rotor elements 348 are shown in their assembled state. The entire assembly is mounted for use by means of mounting tube 304 and mounting threads 108. Output rotational force is transferred to the load by threaded output shaft 352.

FIG. 3F shows the logical-electronic control means 180 of the angular-displacement actuator. Interconnect wiring 312a and 312b from the actuator connects to connection points 372a and 372b of the logical-electronic control means 180. Electrical power is supplied to the logical-electronic control means 180 via connection point 168, and logical control signals are passed to the logical-electronic control means via connection point 172. The control means 180 functions by providing power-electronic drive signals to the multi-salient stator coil 120 of the angular-displacement actuator to affect the movement of the rotor 340 about the stator assembly 300. The instantaneous dynamic current of the stator coils 320 in the stator 300 is monitored by the control means 180 in order to ascertain the position of the rotor 340. Alternately the angular displacement actuator may contain flux sensing windings, or other position sensors, as part of stator coils 320 to provide highly accurate rotor 340 position feedback to the control means 180.

The feedback provided by said position sensor is connected to points 372b, and shown on FIG. 3F as ‘Sense, Se’. The control means 180 is programmed with appropriated mathematical relations to affect the delivery of angular force displacement to the load, and to dynamically adjust the drive parameters by utilizing feedback resulting from monitoring the dynamic current values of the coils 320 in the stator 300, and/or the position sensor. The control means 180 can be programmed, and actuated via the logical control port 172.

What is claimed is:

1. A roto-linear actuator, comprising:
a cylindrical rotor assembly, wherein the rotor assembly has an outer surface and an inner surface, a first end and a second end, and at least one helical groove disposed on the inner surface of the rotor assembly;
a first plurality of magnetic elements associated with the rotor assembly arranged about an axis of rotation;
a cylindrical stator assembly positioned adjacent to the inner surface of the rotor assembly and having at least one helical groove, wherein the stator groove is aligned with the rotor groove, forming a cavity;
a second plurality of magnetic elements associated with the stator assembly arranged about the axis of rotation, wherein the second plurality of magnetic elements are separated from the first plurality of magnetic elements by a gap;
at least one ball positioned within the cavity;
a nose piece extending from the first end of the rotor assembly.

2. The roto-linear actuator of claim 1, wherein the first plurality of magnetic elements are disposed between the outer surface and the inner surface of the rotor assembly.

3. The roto-linear actuator of claim 1, wherein the second plurality of magnetic elements are connected by one of grouped parallel windings, series windings, or series-parallel windings.

4. The roto-linear actuator of claim 1, wherein the second plurality of magnetic elements are arranged about the axis of rotation in a radially regular pattern.

5. The roto-linear actuator of claim 1, wherein the second plurality of magnetic elements are arranged about the axis of rotation in a radially irregular pattern.

6. The roto-linear actuator of claim 1, wherein the first plurality of magnetic elements are arranged about the axis of rotation in a radially regular pattern.

7. The roto-linear actuator of claim 1, wherein the first plurality of magnetic elements are arranged about the axis of rotation in a radially irregular pattern.

8. The roto-linear actuator of claim 1, wherein each of the stator groove and the rotor groove extend not more than about 540 degrees.

9. The roto-linear actuator of claim 1, the stator assembly further comprising a first end and a second end, wherein the first end is adapted to be mounted to a carrier.

10. The roto-linear actuator of claim 1, wherein the nose piece is adapted to secure a tool for use in deep water drilling.

11. The roto-linear actuator of claim 1, the nose piece further comprising a body having a first end and a second end, the first end adapted to connect to the rotor assembly, and an output shaft associated with the second end.

12. The roto-linear actuator of claim 11, wherein the output shaft is free to rotate about the axis of rotation.

13. The roto-linear actuator of claim 11, wherein the output shaft is free to move in a direction parallel to the axis of rotation.

14. An angular displacement actuator, comprising:
a cylindrical rotor assembly, wherein the rotor assembly has an outer surface and an inner surface, and a first end and a second end;
a first plurality of magnetic elements associated with the rotor assembly arranged about an axis of rotation;
a cylindrical stator assembly positioned adjacent to the inner surface of the rotor assembly;
a second plurality of magnetic elements associated with the stator assembly arranged about the axis of rotation, wherein the second plurality of magnetic elements are separated from the first plurality of magnetic elements by a gap; and
an output shaft rigidly extending from the first end of the rotor assembly.
